(19) United States
(12) Patent Application Publication
(10) Pub. No.: US 2012/0017784 A1
(43) Pub. Date: Jan. 26, 2012

(54) METHOD OF PROVIDING A PRINTED DATE

(76) Inventor: James Butcher, Bottesford (GB)

(21) Appl. No.: 13/144,639

(22) PCT Filed: Jan. 19, 2010
(86) PCT No.: PCT/US10/21361

§ 371 Date: Jul. 14, 2011

Related U.S. Application Data
(60) Provisional application No. 61/145,873, filed on Jan. 20, 2009.

(51) Int. Cl. B41F 33/00

(52) U.S. Cl. 101/45; 101/483

(57) ABSTRACT

A method of providing a printed date on a product includes providing an avoidance date, providing a current date, and providing an algorithm for calculating a printed date. The algorithm is used to determine the printed date based on the avoidance date and the current date. The printed date is not the same as the avoidance date. The printed date is printed on the product with a printer.

### BACKGROUND

The present disclosure relates to method and system for providing a printed date on a product.

It is increasingly common for retail establishments to require modification of the printed “Use By” dates on products, based on the retail requirements and merchandising in the store. The most common example of this is “Christmas Coding,” where the Use By date is changed so as to avoid Christmas Day and other key dates such as New Year's Day. For example, if a store is to be closed on Christmas Day, the merchandising process in store is simpler (quicker and therefore cheaper) if on December 24th staff only need to remove from display product with a Display Until December 24th as opposed to searching for and removing product with a Display Until December 24th and product with a Display Until December 25th.

The Use By date is typically provided on a product by a printer. Thus, it would be useful to provide for modification of the Use By date depending on circumstances.

### BRIEF SUMMARY

The present disclosure provides a method of providing a printed date on a product. In particular, an algorithm is used to avoid having the printed date the same as certain “avoidance dates.”

In one aspect, a method of providing a printed date on a product includes providing an avoidance date, providing a current date, and providing an algorithm for calculating a printed date. The algorithm is used to determine the printed date based on the avoidance date and the current date. The printed date is not the same as the avoidance date. The printed date is printed on the product with a printer.

In another aspect, a printing system includes a printer, a printer controller operably connected to the printer, and an algorithm disposed within the printer controller. The printer controller is configured to receive an avoidance date, receive a current date, and use the algorithm to determine a printed date based on the avoidance date and the current date. The printed date is not the same as the avoidance date. The printed date is provided to the printer to print the printed date on a product.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is schematic view of one embodiment of a system for printing a printed date on a product.

### DETAILED DESCRIPTION

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings.

The present disclosure provides a method of providing a printed date (typically a durability date such as a “Use By” date) on a product. In particular, an algorithm is used to avoid having the printed date the same as certain “avoidance dates.” Avoidance dates are related to the process of calendar rules. Depending upon the product and the safe guidelines for product coding, the product life may be extended or reduced so as to avoid a specific date and this is set within the algorithm so as to prevent the printing on the product of the avoidance date. Examples of avoidance dates include holidays like Christmas Day and New Year's Day, where stores are typically closed. It is undesirable to print a Use By date on such an avoidance date. Rather, it is preferably that the printed date be another date, such as the date before the avoidance date.

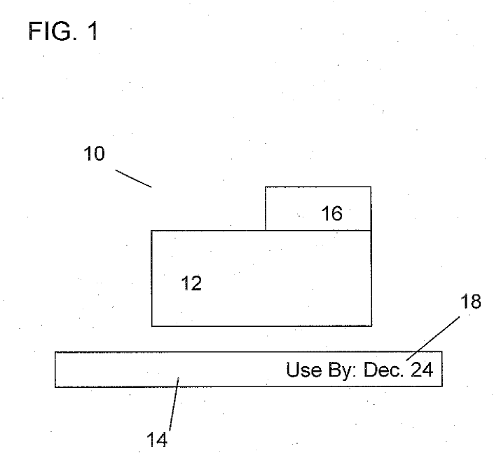

The present system 10, as shown in FIG. 1, includes a printer 12. The printer 12 may be any suitable printer for printing on a product 14, such a continuous ink jet printer. The system 10 includes a controller 16 operably connected to the printer 12. The controller 16 is preferably provided as an internal controller in the printer 12. The controller 16 may also be provided separate from the printer 12, such as a computer or via a network connection. The system 10 includes an algorithm for determining the date 18 to be printed on the product. The controller 16 preferably includes a processor and memory, such as those found in conventional computers and electronic controllers. The printed date 18 may be a durability date, a use-by date, a sell-by date, display-until date, or any other desired date. The printer may print additional information besides the date on the products. The system 10 may be provided on a production line, such as on a conveyor line where the printer prints upon the products as they are conveyed past the printer 12.

The system 10 provides a method of providing a printed date on the product 14. The controller 16 uses an algorithm is to determine the printed date 18 based on the avoidance date and the current date. In one embodiment, the algorithm is stored within the controller for the printer. Alternatively, the algorithm may be provided in a separate controller. The printed date may be, for example, some period of time (e.g. two weeks) later than the current date, and is calculated in an “offset calculation”. The offset calculation may be, for example, PRINTED DATE=CURRENT DATE+14. The algorithm ensures that the printed date is not the same as the avoidance date. An example portion of the algorithm is: “If the Display Until date was going to equal the 25th December, then reduce this to the 24th December.” Stated another way, the algorithm may provide “If PRINTED DATE=AVOIDANCE DATE, then PRINTED DATE=PRINTED DATE −1.” The printed date may be, for example, one day before the avoidance date, one day after the avoidance date, or multiple days before or after the avoidance date.

After the algorithm is used to calculate the printed date and ensure that the printed date is not the same as the avoidance date, the printed date is printed on the product with the printer. The actual image of the printed date may be in any suitable format, such as a calendar date, a day of the week, a Julian date, a coded image that is based on the printed date, and so forth. For example, the image of the printed date may be in a bar-code form that requires a scanner for a user to elucidate the printed date. The printed date does not necessarily have to be a calendar date and may be or include a time, a day of the week, a month, a year, or combinations of these.

The current date may be determined by a system clock (or processor), or entered by a user. The avoidance date may be entered into the controller of the printer by a user. The avoidance date may alternatively be provided in a data file in the controller, or otherwise provided within a memory of the controller. Preferably, the algorithm is automatically applied irrespective of the data source (i.e. the algorithm will automatically be applied whether the data is from the printed message template file, from a data source or from user entry). The calculation, calendar rules and avoidance dates can be stored within the message template or in separate data files cross referenced from the message template. The latter configuration allows a common set of rules to readily be applied to multiple printed message types (multiple message templates) if appropriate. The calculations of the algorithm will typically be performed by a processor, which may be located in a controller within the printer or in an external controller.

The purpose of the algorithm is as a final cross-check to ensure that an avoidance date cannot be printed on the product. The algorithm may be used multiple times to ensure that the printed date is not the same as the avoidance date. Thus, the printed date may be checked against the avoidance date after the offset calculations, rounding, and any other calendar rules that may be present have been applied. If the calculated printed date is an avoidance date, the system may be programmed to fail (i.e. not print) and/or also provide an appropriate error message for a user.

The described and illustrated embodiments are to be considered as illustrative and not restrictive in character, it being understood that only the preferred embodiments have been shown and described and that all changes and modifications that come within the scope of the inventions as defined in the claims are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

What is claimed is:

1. A method of providing a printed date on a product comprising:
providing an avoidance date;
providing a current date;
providing an algorithm for calculating a printed date;
using the algorithm to determine the printed date based on the avoidance date and the current date, wherein the printed date is not the same as the avoidance date; and
printing the printed date on the product with a printer.

2. The method of claim 1 wherein the printer includes a controller.

3. The method of claim 2 wherein the algorithm is stored within the controller for the printer.

4. The method of claim 1 wherein the algorithm provides that the printed date is one day earlier than the avoidance date.

5. The method of claim 1 wherein the algorithm provides that the printed date is one day later than the avoidance date.

6. The method of claim 1 wherein the algorithm includes an offset calculation.

7. The method of claim 1 wherein the printed date is a durability date

8. The method of claim 7 wherein the printed date is a use-by date.

9. The method of claim 1 wherein the current date is determined by a processor.

10. The method of claim 1 wherein the current date is entered by a user.

11. The method of claim 2 wherein the avoidance date is entered into the controller of the printer by a user.

12. The method of claim 2 wherein the avoidance date is provided in a data file in the controller.

13. The method of claim 1 wherein the printer provides an error message if the printed date is the same as an avoidance date.

14. A printing system comprising:
a printer;
a printer controller operably connected to the printer; and
an algorithm disposed within the printer controller, wherein the printer controller is configured to:
receive an avoidance date;
receive a current date;
use the algorithm to determine a printed date based on the avoidance date and the current date, wherein the printed date is not the same as the avoidance date; and
provide the printed date to the printer to print the printed date on a product.

15. The printing system of claim 14 wherein the algorithm is configured to provide that the printed date is one day earlier than the avoidance date.

16. The printing system of claim 14 wherein the algorithm is configured to provide that the printed date is one day later than the avoidance date

17. The printing system of claim 14 wherein the printer controller includes a processor to determine the current date and calculate the printed date.

18. The printing system of claim 14 wherein the system further comprises a data file in the controller that includes the avoidance date.

19. The printing system of claim 14 further comprising a conveyor line for moving products passed the printer.
